(19) United States
(12) Patent Application Publication
(10) Pub. No.: US 2011/0013813 A1
(43) Pub. Date: Jan. 20, 2011

(54) ELECTRONIC DEVICE HAVING AUTHENTICATION FUNCTION AND AUTHENTICATION METHOD

(75) Inventors: Hiroyuki YAMAMOTO, Kawasaki (JP); Kenji Watanabe, Kawasaki (JP); Noriaki Kawaguchi, Kawasaki (JP); Katsuaki Akama, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/835,730

(22) Filed: Jul. 13, 2010

(30) Foreign Application Priority Data
Jul. 14, 2009 (JP) 2009-165438

(51) Int. Cl. G06T 7/00

(52) U.S. Cl. 382/124

(57) ABSTRACT

An electronic device includes a sensor for acquiring data which is input while a relative position of the living body with respect to the sensor is changed, a first authentication portion for obtaining a first detection pattern based on a group of data acquired by the sensor during a period from the start of the acquisition of the data to detection of a stopped state of the change, and for executing a first authentication process by using the first detection pattern, and a second authentication portion for obtaining a second detection pattern different from the first detection pattern, based on a group of data acquired by the sensor during a period from the start of the acquisition of the data to the end of the acquisition of the data after the detection of the stopped state, and for executing a second authentication process by using the second detection pattern.

### CROSS-REFERENCE TO RELATED APPLICATION

This application is based upon and claims the benefit of priority of the prior Japanese Patent Application No. 2009-165438, filed on Jul. 14, 2009, the entire contents of which are incorporated herein by reference.

### FIELD

The embodiments discussed herein are related to a technique for use in realizing an authentication function in an electronic device.

### BACKGROUND

Recently, various authentication methods have been used to protect information in electronic devices such as a portable terminal in which personal information, confidential information, etc., are recorded. One example of a proposed authentication method is to attach a sensor to a portable terminal such as a cellular phone to obtain biometric information of a user and to use the obtained biometric information as an authentication pattern. There is a cellular phone that uses the above-described authentication method, which employs the fingerprint of a user, as the authentication pattern, to protect registered personal information (for example, received messages, address book, etc.) from being read by a third party. However, fingerprint authentication has a risk that the personal information, etc., in the cellular phone may be read by a third party who performs the fingerprint authentication by forcing the finger of a user of the cellular phone to be put on a sensor used for fingerprint authentication, when the user is in an unconscious state such as a deep sleep, or alcohol intoxication.

In consideration of such a risk, a technique is proposed which is intended to enhance the authentication function in the fingerprint authentication by using, for example, an authentication pattern for authenticating the fingerprints of plural fingers of the user in a given order (for example, see Japanese Unexamined Patent Application Publication No. 2001-274897).

With the above-described technique to enhance the authentication function, however, because plural fingers are used for the authentication, operations required for the user are more complicated than the case of using one finger to implement the authentication. In other words, because the authentication pattern is complicated, operations for inputting the authentication pattern become intricate. Further, troublesome operations are necessary for the reason that, when the user causes different fingerprints of plural fingers to be read by a sensor disposed in a cellular phone for the fingerprint authentication, the user has to hold the cellular phone with the other hand during the fingerprint authentication.

### SUMMARY

According to an aspect of the embodiments discussed herein, an electronic device having an authentication function includes a sensor for acquiring data related to a living body, which is input while a relative position of the living body with respect to the sensor is changed, a first authentication portion for obtaining a first detection pattern based on a group of data which have been acquired by the sensor during a period from the start of the acquisition of the data by the sensor to detection of a stopped state of change in the relative position, and for executing a first authentication process by using the first detection pattern, and a second authentication portion for obtaining a second detection pattern, which differs from the first detection pattern, based on a group of data which have been acquired by the sensor during a period from the start of the acquisition of the data by the sensor to the end of the acquisition of the data by the sensor after the detection of the stopped state, and for executing a second authentication process by using the second detection pattern.

It is to be understood that both the foregoing general description and the following detailed description are exemplary and explanatory and are not restrictive of the embodiments, as claimed.

### BRIEF DESCRIPTION OF DRAWINGS

FIGS. 1A and 1B are each an external appearance view of a cellular phone according to a first embodiment;

FIG. 2 is a functional block diagram illustrating configuration of the cellular phone of FIGS. 1A and 1B;

FIG. 3 is a flowchart illustrating a fingerprint registration process in the cellular phone of FIG. 2;

FIG. 4 is a flowchart illustrating a fingerprint authentication process in the cellular phone of FIG. 2;

FIGS. 5A and 5B are each an explanatory view regarding a fingerprint reading process in the cellular phone of FIG. 2;

FIG. 6 is an explanatory view regarding the fingerprint registration process and the fingerprint authentication process in the cellular phone in FIG. 2; and

FIGS. 7A and 7B are explanatory views regarding a fingerprint registration process and a fingerprint authentication process in a cellular phone according to a second embodiment.

### DESCRIPTION OF EMBODIMENTS

### First Embodiment

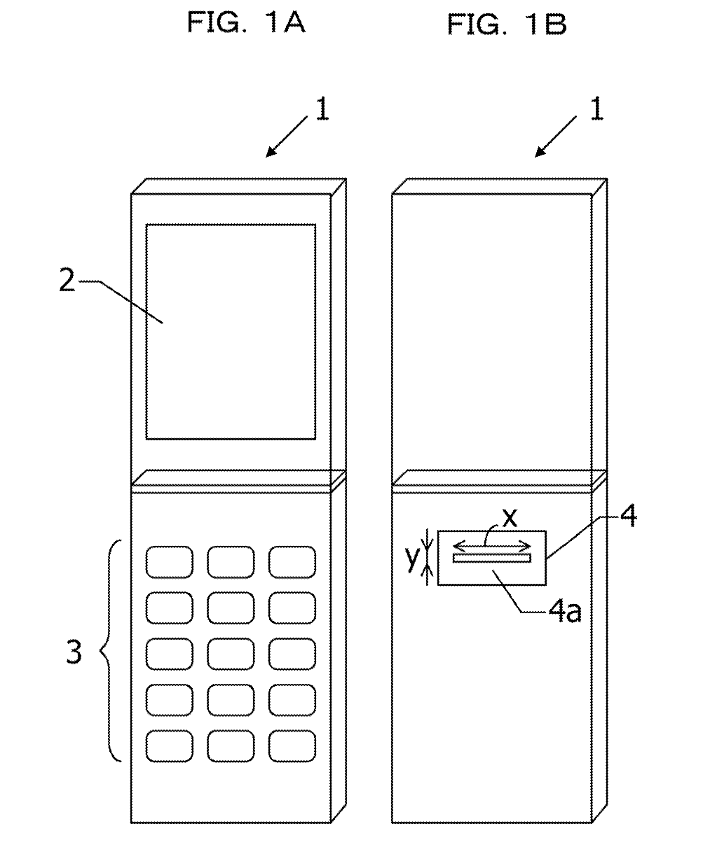

A first embodiment of an electronic device having an authentication function, i.e., cellular phone 1, which is disclosed herein, will be described below with reference to FIGS. 1 to 6. The cellular phone 1 includes, for example, a verbal communication (telephone) function and an e-mail function via external radio (wireless) communication. Further, the cellular phone 1 stores personal information, such as an address book for use in executing the verbal communication function and the e-mail function, a log of outgoing and incoming phone calls, as well as sent and received mail data. In this respect, the cellular phone 1 has an authentication function allowing a user to execute each of the previously described functions. In the first embodiment, authentication is carried out by using biometric data, a fingerprint image of a finger of the user of the cellular phone 1.

FIGS. 1A and 1B are each an external appearance view of the cellular phone 1. As illustrated in FIG. 1A, a display portion (screen) 2 and an operation input portion 3 are disposed on one surface (front surface) of the cellular phone 1. The display portion 2 is constituted by, for example, an LCD (Liquid Crystal Display) and may be used, for example, to present information and to display a cursor for selecting information. The operation input portion 3 is constituted by, for example, a keypad and includes a plurality of key switches which are arranged thereon for key inputting.

Also, as illustrated in FIG. 1B, a sweep fingerprint sensor 4 is disposed on the other surface (rear surface) of the cellular phone 1. The sweep fingerprint sensor 4 includes a line-shaped sensitive surface 4a that has a given horizontal width×[mm] (that is determined depending on, for example, an average finger width). Corresponding to a sliding motion of the finger over the sensitive surface 4a, the sweep fingerprint sensor 4 sequentially acquires image data of a portion of the finger, which is positioned to face the sensitive surface 4a. The sweep fingerprint sensor 4 may be used as, for example, an optical type, an electrostatic capacitive type, or a heat sensitive type. For example, the sweep fingerprint sensor 4 operates such that it starts to acquire the image data upon detecting contact of the finger against the sensitive surface 4a and ends the acquisition of the image data upon detecting no more contact of the finger against the sensitive surface 4a. Stated another way, when the user puts the finger on the sensitive surface 4a and slides it in the direction of a vertical width y (i.e., changes a relative position of the finger to the sweep fingerprint sensor 4), a partial fingerprint image is sequentially taken through the sweep fingerprint sensor 4 and a fingerprint image is eventually acquired from a group of partial fingerprint images.

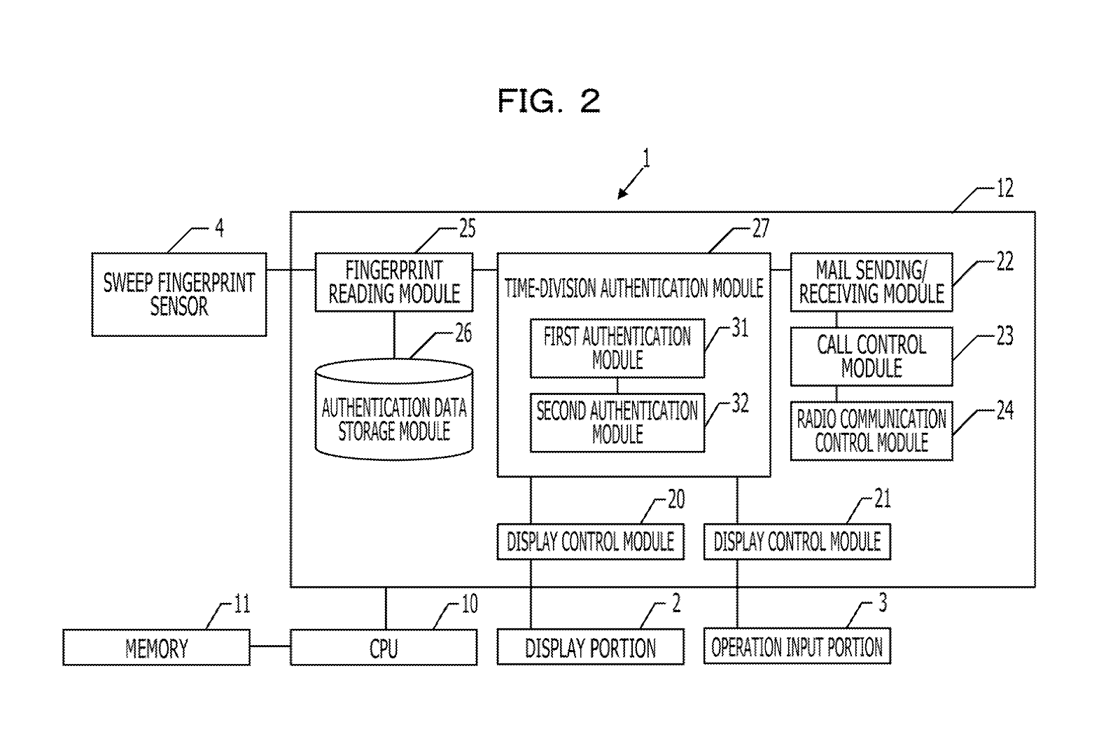

FIG. 2 is a functional block diagram of the cellular phone 1. The cellular phone 1 includes an electronic unit which contains a CPU (Central Processing Unit) 10, a memory 11 including a ROM (Read Only memory) and a RAM (Random Access Memory), etc. The functions of the electronic unit are implemented by a control section 12 which executes various kinds of information processing. The display portion 2, the operation input portion 3, and the sweep fingerprint sensor 4 are connected to the control section 12.

The memory 11 stores therein personal information of the user of the cellular phone 1 and data settings for use in executing various functions of the cellular phone 1. The personal information includes, for example, registered data of telephone numbers, e-mail addresses, etc., sent and received mail data, as well as a history of received (incoming) and sent (outgoing) messages and phone calls. The data settings includes, for example, display parameters used when a fingerprint registration screen and a fingerprint authentication screen, described later, are displayed on the display portion 2.

Further, the memory 11 stores therein programs for realizing the various functions of the cellular phone 1. In other words, the various functions of the cellular phone 1 are realized by the CPU 10 that executes the programs stored in the memory 11.

The control section 12 includes, as function modules, a display control module 20, an input control module 21, a mail sending/receiving module 22, a call control module 23, and a radio communication control module 24. The display control module 20 executes a process of preparing a screen which is to be displayed on the display portion 2, and a process of displaying the prepared screen. When any key switch on the operation input portion 3 is pressed, the input control module 21 receives an operation input and executes a process corresponding to the operation input. The mail sending/receiving module 22 executes reception of mail data, sending of prepared mail data, and control in relation to the sent and received mail data. The call control module 23 executes control of connection and disconnection of a communication line. The radio communication control module 24 includes a radio transmitting/receiving module for transmitting and receiving a high-frequency signal, and a signal processing module for performing voice and data signal processing, thus executing voice and data radio transmission/reception with respect to an external radio base station, etc.

The control section 12 further includes a fingerprint reading module 25, an authentication data storage module 26, and a time-division authentication module 27.

The fingerprint reading module 25 sequentially acquires the partial fingerprint image through the sweep fingerprint sensor 4. The fingerprint reading module 25 has the performance capable of acquiring image data at a processing speed sufficiently higher than the speed of the moving finger. Further, whenever the fingerprint reading module 25 reads the image data corresponding to the sliding motion of the finger, the fingerprint reading module 25 notifies the read image data, as the partial fingerprint image, to the time-division authentication module 27.

The time-division authentication module 27 receives the notification from the fingerprint reading module 25 and produces a fingerprint image from a group of partial fingerprint images by joining a newly-acquired partial fingerprint image with an already-acquired partial fingerprint image in order to combine both the images together.

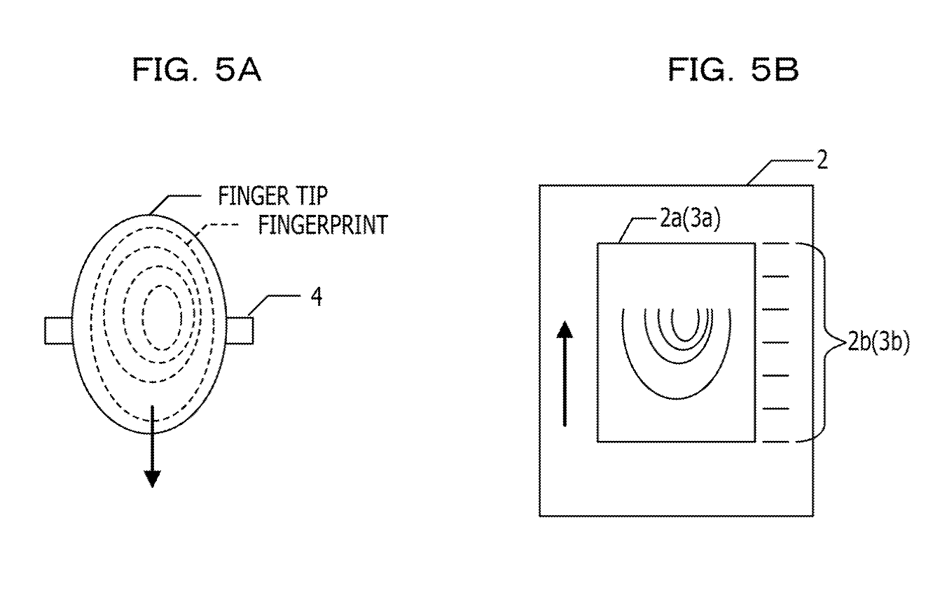

Further, the time-division authentication module 27 executes a fingerprint registration process of registering a registration pattern, which is obtained based on the fingerprint image of the user, in the authentication data storage module 26, and a fingerprint authentication process of executing the authentication by comparing a detection pattern, which is also obtained based on the fingerprint image of the user, with the registration pattern. The time-division authentication module 27 displays the fingerprint registration screen on the display portion 2 in the fingerprint registration process and the fingerprint authentication screen on the display portion 2 in the fingerprint authentication process. On both the fingerprint registration screen and the fingerprint authentication screen, the fingerprint image acquired by the sweep fingerprint sensor 4 is displayed in a manner enabling the user to visually confirm a degree of the progress in the acquisition of the fingerprint image (see FIG. 5B described later).

More specifically, the time-division authentication module 27 includes a first authentication module 31 and a second authentication module 32. In the fingerprint registration process, the first authentication module 31 obtains a first registration pattern (registration pattern 1) based on a group of partial fingerprint images which have been acquired by the sweep fingerprint sensor 4 during a period from the start of acquisition of image data by the sweep fingerprint sensor 4 to the detection of a stopped state of the finger sliding motion. Then, the first authentication module 31 registers the obtained first registration pattern in the authentication data storage module 26.

Also, in the fingerprint registration process, the second authentication module 32 obtains a second registration pattern (registration pattern 2) based on a group of partial fingerprint images which have been acquired by the sweep fingerprint sensor 4 during a period until the end of the acquisition of the image data by the sweep fingerprint sensor 4 after obtaining the first registration pattern. Then, the second authentication module 32 registers the obtained second registration pattern in the authentication data storage module 26.

In the fingerprint authentication process, the first authentication module 31 acquires a first detection pattern based on a group of partial fingerprint images which have been acquired by the sweep fingerprint sensor 4 during a period from the start of the acquisition of the image data by the sweep fingerprint sensor 4 to the detection of the stopped state of the finger sliding motion. Then, the first authentication module 31 executes a first authentication process by comparing the first detection pattern with the first registration pattern which has been registered in advance, thus executing a first authentication process. In the first authentication process, if a degree of similarity between the first detection pattern and the first registration pattern is not smaller than a given value, the first authentication module 31 determines that the first detection pattern and the first registration pattern are matched with each other.

Also, in the fingerprint authentication process, the second authentication module 32 acquires a second detection pattern based on a group of partial fingerprint images which have been acquired by the sweep fingerprint sensor 4 during the period until the end of the acquisition of the image data by the sweep fingerprint sensor 4 after obtaining the first detection pattern. Then, the second authentication module 32 executes a second authentication process by comparing the second detection pattern with the second registration pattern which has been registered in advance. In the second authentication process, if a degree of similarity between the second detection pattern and the second registration pattern is not smaller than a given value, the second authentication module 32 determines that the second detection pattern and the second registration pattern are matched with each other.

On that occasion, the second authentication module 32 executes the second authentication process when the first authentication module 31 determines as a result of the first authentication process that the first detection pattern and the first registration pattern are matched with each other. Further, when it is determined as a result of the second authentication process that the second detection pattern and the second registration pattern are matched with each other, the authentication is regarded as having succeeded.

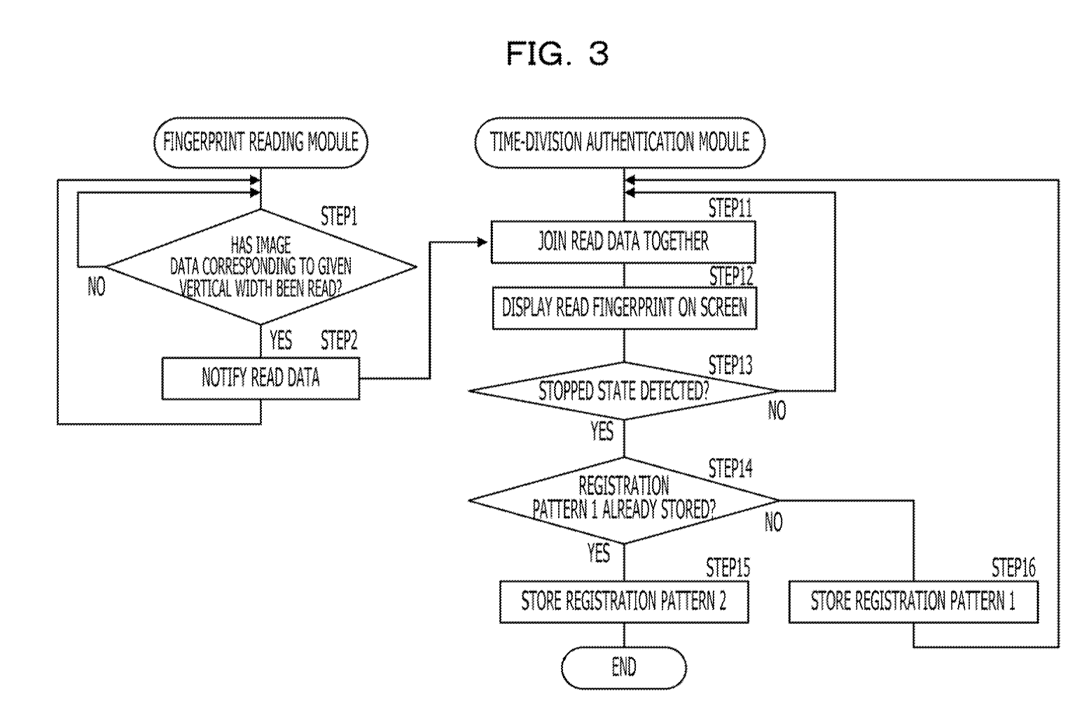

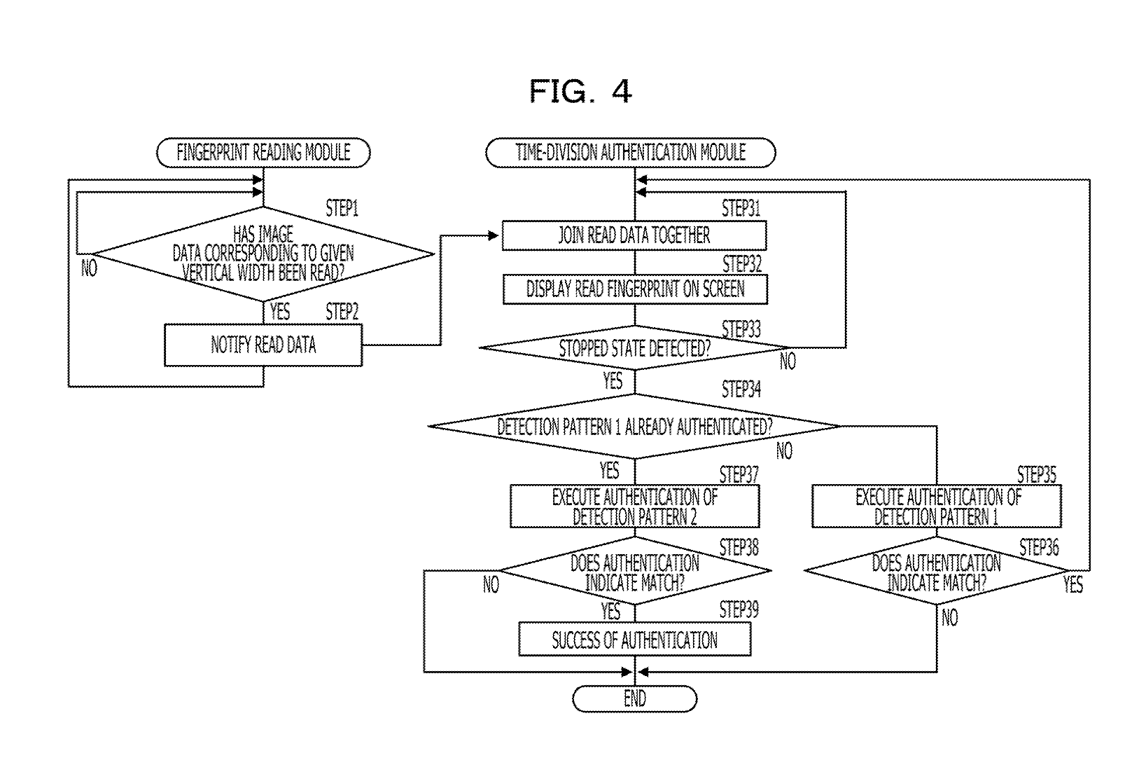

The operation of the cellular phone 1 according to the first embodiment will be described below with reference to flowcharts of FIGS. 3 and 4. First, the fingerprint registration process is described with reference to the flowchart of FIG. 3. The fingerprint registration process is started, for example, by the user operating the operation input portion 3 so as to execute the fingerprint registration function from, for example, a menu screen of the cellular phone 1. In an initial state, the fingerprint registration screen is displayed on the display portion 2. Near a fingerprint image display area 2a of the fingerprint registration screen, a scale 2b is displayed which serves as an index for visually confirming a degree of the progress in the acquisition of the fingerprint image (see later-described FIG. 5B).

In the fingerprint registration process, the user puts the finger on the sensitive surface 4a of the sweep fingerprint sensor 4 and slides the finger while the sweep fingerprint sensor 4 sequentially acquires image data corresponding to the sliding motion of the finger. Further, the fingerprint reading module 25 repeats the following processing of STEP 1 to 2 and the time-division authentication module 27 executes the following processing of STEP 11 to 16.

The processing executed by the fingerprint reading module 25 in the fingerprint registration process is now described. The fingerprint reading module 25 determines whether the image data has been read by the sweep fingerprint sensor 4 over a given vertical width a (for example, 2 mm) or more (STEP 1). The given vertical width a is set to be, for example, certain times as large as the vertical width y of the sensitive surface 4a. If the read data covers a region less than the given vertical width a (i.e., if the determination result in STEP 1 is “NO”), the determination in STEP 1 is repeated. On the other hand, if the acquired data covers a region of the given vertical width a or more (i.e., if the determination result in STEP 1 is “YES”), the fingerprint reading module 25 notifies the read data, as the partial fingerprint image, to the time-division authentication module 27 (STEP 2) and returns to STEP 1 to repeat the processing of STEP 1 to 2 until the fingerprint registration process is finished.

The processing executed by the time-division authentication module 27 in the fingerprint registration process is now described. Upon receiving the notification of the read data from the fingerprint reading module 25, the time-division authentication module 27 executes a correction process, such as gray scale processing, on a newly-acquired partial fingerprint image and joins it with an already-acquired fingerprint image in order to combine both the images together (STEP 11). In a first processing cycle, the time-division authentication module 27 executes the correction process, such as gray scale processing, on the received read data and regards the corrected data to be the fingerprint image as it is. Thus, a fingerprint image is obtained from a group of partial fingerprint images.

Then, the time-division authentication module 27 instructs the display control module 20 to display the acquired fingerprint image in the fingerprint area 2a of the fingerprint registration screen on the display portion 2 (STEP 12). As a result, an already-acquired part of the fingerprint image is displayed in the fingerprint image area 2a.

The fingerprint reading process is now described in relation with an example illustrated in FIGS. 5A and 5B. FIG. 5A illustrates a state where the user puts the finger on the sensitive surface 4a of the sweep fingerprint sensor 4 and slides the finger. As illustrated in FIG. 5A, the finger is moved relative to the sweep fingerprint sensor 4 in the direction indicated by an arrow. At that time, as illustrated in FIG. 5B, the already-acquired part of the fingerprint image is displayed in the fingerprint image area 2a of the fingerprint registration screen, which is displayed on the display portion 2. The user may visually confirm a degree of the progress in the acquisition of the fingerprint image by comparing the fingerprint image displayed in the fingerprint image area 2a with the scale 2b on the fingerprint registration screen.

Then, the time-division authentication module 27 determines whether the stopped state of the finger sliding motion has been detected (STEP 13). For example, when the finger is stopped (or the moving speed of the finger is not higher than a given speed that may be regarded as corresponding to the stopped state) for a given time (for example, 2 seconds) or longer, the time-division authentication module 27 determines that the stopped state of the finger sliding motion has been detected. As one practical example, in the first embodiment, when the notification of the read data is not notified from the fingerprint reading module 25 for the given time or longer, the time-division authentication module 27 detects that the finger is in the stopped state.

Thus, when the time-division authentication module 27 receives the notification of the next read data within the given time after receiving the notification of the previous read data, the time-division authentication module 27 determines that the stopped state is not yet detected (i.e., that the determination result in STEP 13 is “NO”), followed by returning to STEP 11. Thereafter, the time-division authentication module 27 repeats the processing of STEP 11 to 13 on the received read data. In such a way, until the stopped state is detected in STEP 13, a partial fingerprint image is acquired per lot of read data from the lower end of the finger in STEP 11, and the acquired partial fingerprint images are successively displayed in the fingerprint image area 2a in STEP 12. Accordingly, the user may slide the finger while visually confirming a degree of the progress in the acquisition of the fingerprint image and may stop the sliding motion of the finger at a desired division rate at which the fingerprint is to be registered (for example, in a state where the fingerprint data has been read to 70% of the entire fingerprint).

On the other hand, when the time-division authentication module 27 does not receive the notification of the next read data within the given time after receiving the notification of the previous read data, the time-division authentication module 27 determines that the stopped state has been detected (i.e., that the determination result in STEP 13 is “YES”), followed by advancing to STEP 14.

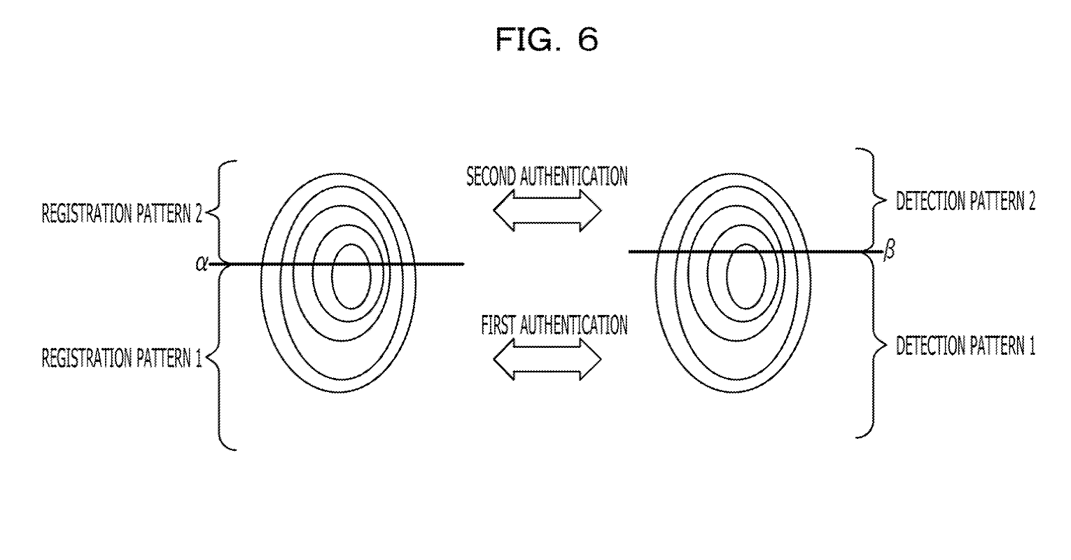

Then, the time-division authentication module 27 determines whether the registration pattern 1 is already registered in the authentication data storage module 26 (STEP 14). If the registration pattern 1 is not yet stored (i.e., if the determination result in STEP 14 is “NO”), the first authentication module 31 obtains the registration pattern 1 based on the fingerprint image which has been acquired by the sweep fingerprint sensor 4 during the period from the start of the acquisition of the image data by the sweep fingerprint sensor 4 to the detection of the stopped state of the finger sliding motion. FIG. 6 illustrates one example of the obtained registration pattern 1. In FIG. 6, α represents a position where the stopped state has been detected. The registration pattern 1 may be the image data per se of the fingerprint image or feature value (information) data extracted from the fingerprint image. Then, the first authentication module 31 stores the obtained registration pattern 1 in the authentication data storage module 26 (STEP 16). Thereafter, the processing returns to STEP 11.

On the other hand, if the registration pattern 1 is already stored (i.e., if the determination result in STEP 14 is “YES”), the stopped state detected in STEP 13 is regarded as indicating the end of the acquisition of the image data by the sweep fingerprint sensor 4. In such a case, the second authentication module 32 obtains the registration pattern 2 based on the fingerprint image which has been acquired by the sweep fingerprint sensor 4 during the period until the end of the acquisition of the image data by the sweep fingerprint sensor 4 after obtaining the registration pattern 1. FIG. 6 illustrates one example of the obtained registration pattern 2. The registration pattern 2 may be the image data per se of the fingerprint image or feature value (information) data extracted from the fingerprint image. Also, the registration pattern 2 may be obtained through processing that is the same as or differs from the processing used to obtain the registration pattern 1. Then, the second authentication module 32 stores the obtained registration pattern 2 in the authentication data storage module 26 (STEP 15). Thereafter, the fingerprint registration process is finished.

Next, the fingerprint authentication process is described with reference to the flowchart of FIG. 4. The fingerprint authentication process is started, for example, by the user operating the operation input portion 3 so as to execute any function, which accompanies with display of personal information, from, for example, the menu screen of the cellular phone 1. In an initial state, the fingerprint authentication screen is displayed on the display portion 2. As in the fingerprint registration screen illustrated in FIG. 5B, near a fingerprint image display area 3a of the fingerprint authentication screen, a scale 3b is displayed which serves as an index for visually confirming a degree of the progress in the acquisition of the fingerprint image.

In the fingerprint authentication process, as in the fingerprint registration process, the user puts the finger on the sensitive surface 4a of the sweep fingerprint sensor 4 and slides the finger, while the sweep fingerprint sensor 4 sequentially acquires image data corresponding to the sliding motion of the finger. Further, the fingerprint reading module 25 repeats the following processing of STEP 21 to 22 and the time-division authentication module 27 executes the following processing of STEP 31 to 39.

The processing executed by the fingerprint reading module 25 in the fingerprint authentication process is now described. As in the fingerprint registration process, the fingerprint reading module 25 determines whether the image data has been read by the sweep fingerprint sensor 4 over a given vertical width a (for example, 2 mm) or more (STEP 21). If the read data covers a region of less than the given vertical width a (i.e., if the determination result in STEP 21 is “NO”), the determination in STEP 21 is repeated. On the other hand, if the acquired data covers a region of the given vertical width a or more (i.e., if the determination result in STEP 21 is “YES”), the fingerprint reading module 25 notifies the read data, as the partial fingerprint image, to the time-division authentication module 27 (STEP 22) and returns to STEP 21 to repeat the processing of STEP 21 to 22 until the fingerprint authentication process is finished.

The processing executed by the time-division authentication module 27 in the fingerprint authentication process is now described. As in the fingerprint registration process, upon receiving the notification of the read data from the fingerprint reading module 25, the time-division authentication module 27 executes a correction process, such as gray scale processing, on a newly-acquired partial fingerprint image and joins it with an already-acquired fingerprint image in order to combine both the images together (STEP 31). Thus, a fingerprint image is obtained from a group of partial fingerprint images.

Then, as in the fingerprint registration process, the time-division authentication module 27 instructs the display control module 20 to display the acquired fingerprint image in the fingerprint area 3a of the fingerprint registration screen on the display portion 2 (STEP 32). As a result, an already-acquired part of the fingerprint image is displayed in the fingerprint image area 3a. At that time, the user may visually confirm a degree of the progress in the acquisition of the fingerprint image by comparing the fingerprint image displayed in the fingerprint image area 3a with the scale 3b on the fingerprint authentication screen.

Then, as in the fingerprint registration process, the time-division authentication module 27 determines whether the stopped state of the finger sliding motion has been detected (STEP 33). When the time-division authentication module 27 receives the notification of the next read data within the given time after receiving the notification of the previous read data, the time-division authentication module 27 determines that the stopped state is not yet detected (i.e., that the determination result in STEP 33 is “NO”), followed by returning to STEP 31. Thereafter, the time-division authentication module 27 repeats the processing of STEP 31 to 33 on the received read data. In such a way, until the stopped state is detected in STEP 33, a partial fingerprint image is acquired per lot of read data from the lower end of the finger in STEP 31, and the acquired partial fingerprint images are successively displayed in the fingerprint image area 3a in STEP 32. Accordingly, the user may slide the finger while visually confirming a degree of the progress in the acquisition of the fingerprint image and may stop the sliding motion of the finger at the stopped position at which the fingerprint has been registered.

On the other hand, when the time-division authentication module 27 does not receive the notification of the next read data within the given time after receiving the notification of the previous read data, the time-division authentication module 27 determines that the stopped state has been detected (i.e., that the determination result in STEP 33 is “YES”), followed by advancing to STEP 34.

Then, the time-division authentication module 27 determines whether a detection pattern 1 is already authenticated (STEP 34). If the detection pattern 1 is not yet authenticated (i.e., if the determination result in STEP 34 is “NO”), the first authentication module 31 obtains the detection pattern 1 through the same processing as that for the registration pattern based on the fingerprint image which has been acquired by the sweep fingerprint sensor 4 during the period from the start of the acquisition of the image data by the sweep fingerprint sensor 4 to the detection of the stopped state of the finger sliding motion. FIG. 6 illustrates one example of the obtained detection pattern 1. In FIG. 6, β represents a position where the stopped state has been detected. Then, the first authentication module 31 compares the obtained detection pattern 1 with the registration pattern 1 stored in the authentication data storage module 26, thereby executing a first authentication process (STEP 35). More specifically, the first authentication module 31 calculates a degree of similarity between the detection pattern 1 and the registration pattern 1.

Then, the first authentication module 31 determines whether the authentication result indicates a match (STEP 36). More specifically, when the degree of similarity between the detection pattern 1 and the registration pattern 1 is not smaller than a given value, the first authentication module 31 determines that the authentication result indicates a match. In such a way, the authentication is performed with respect to matching of one part of the fingerprint image, which has been time-divided by the user stopping the sliding motion of the finger.

If the first authentication module 31 determines that the authentication result does not indicate a match (i.e., that the determination result in STEP 36 is “NO”), the authentication is regarded as not having succeeded and the fingerprint authentication process is finished at once. If the first authentication module 31 determines that the authentication result indicates a match (i.e., that the determination result in STEP 36 is “YES”), first authentication is regarded as having succeeded and the processing returns to STEP 31.

On the other hand, if the detection pattern 1 is already authenticated (i.e., if the determination result in STEP 34 is “YES”), this is regarded as indicating that the first authentication has succeeded and the stopped state detected in STEP 33 indicates the end of the acquisition of the image data by the sweep fingerprint sensor 4. In such a case, the second authentication module 32 obtains a detection pattern 2 through the same processing as that for the registration pattern based on the fingerprint image which has been acquired by the sweep fingerprint sensor 4 during the period until the end of the acquisition of the image data by the sweep fingerprint sensor 4 after obtaining the detection pattern 1. FIG. 6 illustrates one example of the obtained detection pattern 2. Then, the second authentication module 32 compares the obtained detection pattern 2 with the registration pattern 2 stored in the authentication data storage module 26, thereby executing a second authentication process (STEP 37). More specifically, the second authentication module 32 calculates a degree of similarity between the detection pattern 2 and the registration pattern 2.

Then, the second authentication module 32 determines whether the authentication result indicates a match (STEP 38). More specifically, when the degree of similarity between the detection pattern 2 and the registration pattern 2 is not smaller than a given value, the second authentication module 32 determines that the authentication result indicates a match. In such a way, the authentication is performed with respect to matching of the other part of the fingerprint image, which has been time-divided by the user stopping the sliding motion of the finger.

If the second authentication module 32 determines that the authentication result does not indicate a match (i.e., that the determination result in STEP 38 is “NO”), the authentication is regarded as not having succeeded and the fingerprint authentication process is finished at once. If the second authentication module 32 determines that the authentication result indicates a match (i.e., that the determination result in STEP 38 is “YES”), second authentication is regarded as having succeeded (STEP 39). Accordingly, the fingerprint authentication process is finished after allowing display of the personal information.

With the fingerprint registration process and the fingerprint authentication process according to the first embodiment, the authentication may be executed with a simple operation of time-dividing a pattern, for example, with the user temporarily stopping the finger sliding operation. On that occasion, it is hard for a third party to recognize the timing at which the user has temporarily stopped the finger sliding operation. In other words, a difficulty arises in succeeding the authentication, for example, even when the third party attempts the finger authentication by employing the finger of the user against the user's will. Thus, by executing the authentication in the time-divided manner as described above, it is possible to avoid such a situation that the personal information stored in the cellular phone 1 is read, for example, with manipulations by the third party.

Hence, according to the first embodiment, the authentication function may be enhanced while maintaining good operability.

While, in the first embodiment, the second registration pattern and the second detection pattern are each obtained based on the group of partial fingerprint images which have been acquired by the sweep fingerprint sensor 4 during the period until the end of the acquisition of the image data by the sweep fingerprint sensor 4 after obtaining the first detection pattern, a method of obtaining the second registration pattern and the second detection pattern is not limited to the above-described example. For example, the second registration pattern and the second detection pattern may each be obtained based on a group of all data which have been acquired by the sweep fingerprint sensor 4 during the period from the start to the end of the acquisition of the image data, or based on a group of given partial data differing from the group of data based on which the first registration pattern and the first detection pattern have been obtained.

### Second Embodiment

A second embodiment of an electronic device having an authentication function, which is disclosed herein, will be described below. The second embodiment differs from the first embodiment in the processing executed by the first authentication module 31 and the second authentication module 32. The same components as the components described in the first embodiment are denoted by the same reference numerals and descriptions of the components are omitted.

In the fingerprint registration process according to the second embodiment, the first authentication module 31 and the second authentication module 32 obtain the first registration pattern and the second registration pattern, respectively, based on the group of partial fingerprint images which have been acquired by the sweep fingerprint sensor 4 during the period from the start of the acquisition of the image data by the sweep fingerprint sensor 4 to the detection of the stopped state of the finger sliding motion. Thus, it is assumed in the second embodiment that the registration pattern is provided as image data per se of the fingerprint image which has been acquired by the sweep fingerprint sensor 4 during the period from the start of the acquisition of the image data by the sweep fingerprint sensor 4 to the detection of the stopped state of the finger sliding motion, and that the first registration pattern and the second registration pattern are the same image data.

In the fingerprint authentication process, as in the fingerprint registration process, the first authentication module 31 and the second authentication module 32 obtain the first detection pattern and the second detection pattern, respectively, based on the group of partial fingerprint images which have been acquired by the sweep fingerprint sensor 4 during the period from the start of the acquisition of the image data by the sweep fingerprint sensor 4 to the detection of the stopped state of the finger sliding motion. In the second embodiment, the detection pattern is provided as image data per se of the acquired fingerprint image similarly to the registration pattern.

Further, the first authentication module 31 and the second authentication module 32 execute, as a first authentication process and a second authentication process, different authentication processes in such a manner that the second authentication process has higher authentication accuracy than the first authentication process. More specifically, the first authentication process executes an authentication process regarding the timing at which the finger sliding operation is stopped in the process of acquiring the fingerprint image as the first detection pattern, and the second authentication process executes an authentication process regarding the fingerprint image which has been acquired as the second detection pattern.

The first authentication module 31 determines that the first detection pattern and the first registration pattern are matched with each other (i.e., matching in the stop timing of the finger sliding motion), when a position of the terminal end of the first detection pattern relative to the start end thereof and a position of the terminal end of the first registration pattern relative to the start end thereof fall within a given range. Also, the second authentication module 32 determines that the second detection pattern and the second registration pattern are matched with each other (i.e., matching in the fingerprint image), when a degree of similarity between the second detection pattern and the second registration pattern is not smaller than a given value. On that occasion, the second authentication module 32 executes the second authentication process only when the result of the first authentication process executed by the first authentication module 31 indicates that the first detection pattern and the first registration pattern are matched with each other.

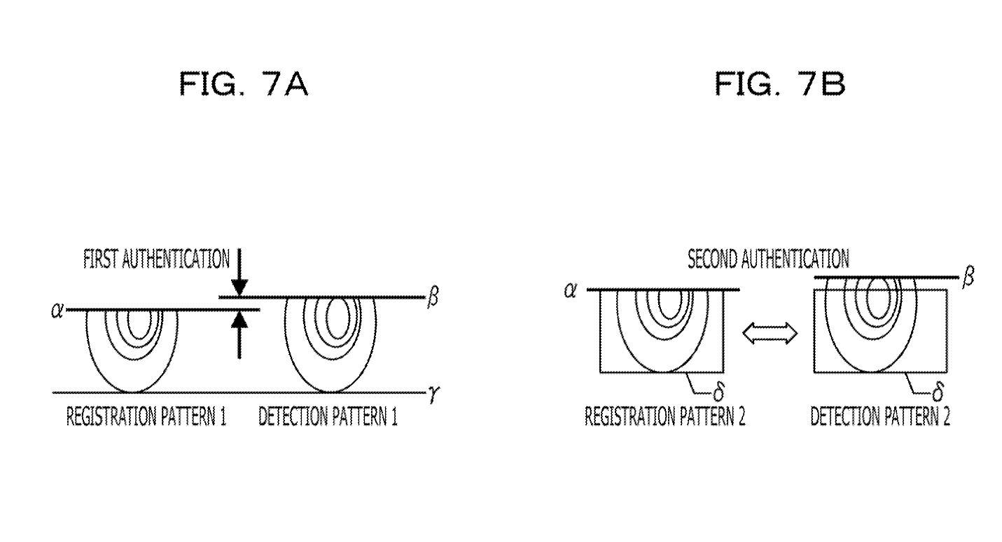

The fingerprint authentication process according to the second embodiment will be described below with reference to FIGS. 7A and 7B. FIG. 7A represents one example of the first authentication process. In the first authentication process, the first authentication module 31 compares the position α of the terminal end of the detection pattern 1 relative to the start end γ with the position β of the terminal end of the registration pattern 1 relative to the start end γ thereof. For example, the first authentication module 31 determines whether β falls within a given range (i.e., within ±10% of the vertical width of the entire fingerprint) with respect to α. If so, the first authentication module 31 determines that the positions (stop timings) α and β are matched with each other (i.e., that the first authentication has succeeded). In such a way, the authentication regarding the stop timing of the finger may be executed based on the fingerprint image which has been time-divided with the user stopping the finger sliding motion. Thus, in the first authentication process, the authentication may be quickly executed by a simple process of just comparing the positions.

FIG. 7B represents one example of the second authentication process. In the second authentication process, the second authentication module 32 compares common regions δ of the detection pattern 2 and the registration pattern 2 with each other. If a degree of similarity between the two patterns in the common regions γ is not smaller than a given value, the second authentication module 32 determines that the fingerprint images are matched with each other (i.e., that the second authentication has succeeded). As a result, the authentication regarding the fingerprint image per se may be executed based on the fingerprint image which has been time-divided with the user stopping the finger sliding motion. Thus, in the second authentication process, the authentication may be executed on the fingerprint image per se, for which the first authentication has succeeded, with higher authentication accuracy.

According to the second embodiment, as in the first embodiment, the authentication function may be enhanced while maintaining good operability.

While, in the second embodiment, the second registration pattern and the second detection pattern are each obtained based on the same partial fingerprint images as the fingerprint images based on which the first registration pattern and the first detection pattern have been obtained, a method of obtaining the second registration pattern and the second detection pattern is not limited to the above-described example. For example, the second registration pattern and the second detection pattern may each be obtained based on a group of all data which have been acquired by the sweep fingerprint sensor 4 during the period from the start to the end of the acquisition of the image data, or based on another group of given partial data.

While, in the first and second embodiments, the authentication is executed by time-dividing each of the registration pattern and the detection pattern into two parts, the authentication may be executed by time-dividing each of those patterns into three or more parts, for example.

Also, while, in the first and second embodiments, the fingerprint of the user is employed as data related to a living body (i.e., biometric data), the biometric data is not limited to the fingerprint of the user. As another embodiment, the electronic device may be applied to the case where a hand-written sign of the user is employed as the biometric data.

Further, while, in the first and second embodiments, the cellular phone is employed as the electronic device having the authentication function, some other suitable device, such as a PDA (Personal Digital Assistant), may also be employed as the electronic device.

According to the electronic device having the authentication function and the authentication method which are disclosed herein, the authentication function may be enhanced while maintaining good operability.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An electronic device having an authentication function comprising:
a sensor for acquiring data related to a living body, which is input while a relative position of the living body with respect to the sensor is changed;
a first authentication portion for obtaining a first detection pattern based on a group of data which have been acquired by the sensor during a period from the start of the acquisition of the data by the sensor to detection of a stopped state of the change in the relative position, and for executing a first authentication process by using the first detection pattern; and
a second authentication portion for obtaining a second detection pattern, which differs from the first detection pattern, based on a group of data which have been acquired by the sensor during a period from the start of the acquisition of the data by the sensor to the end of the acquisition of the data by the sensor after the detection of the stopped state, and for executing a second authentication process by using the second detection pattern.

2. The electronic device according to claim 1, wherein the second authentication portion obtains the second detection pattern based on a group of data which have been acquired by the sensor during a period until the end of the acquisition of the data by the sensor after obtaining the first detection pattern, and executes the second authentication process.

3. The electronic device according to claim 1, wherein the second authentication portion obtains the second detection pattern through processing, which differs from that used to obtain the first detection pattern, based on the same group of data as the group used to obtain the first detection pattern, and executes the second authentication process.

4. The electronic device according to claim 1, wherein the first authentication portion executes, as the first authentication process, an authentication process regarding the detection of the stopped state when the first detection pattern is obtained, and the second authentication portion executes, as the second authentication process, an authentication process regarding the second detection pattern per se.

5. The electronic device according to claim 1, wherein the second authentication portion executes the second authentication process when the first authentication process has succeeded.

6. The electronic device according to claim 1, further comprising a display portion for displaying, in a visually recognizable manner, a degree of progress in the acquisition of the data related to the living body by the sensor.

7. The electronic device according to claim 1, wherein the data related to the living body is a fingerprint image, and
the sensor is a sweep fingerprint sensor.

8. An authentication method for executing authentication comprising:
acquiring, through a sensor, data related to a living body, which is input while a relative position of the living body with respect to the sensor is changed;
obtaining a first detection pattern based on a group of data which have been acquired by the sensor during a period from the start of the acquisition of the data by the sensor to detection of a stopped state of the change in the relative position, and executing a first authentication process by using the first detection pattern; and
obtaining a second detection pattern, which differs from the first detection pattern, based on a group of data which have been acquired by the sensor during a period from the start of the acquisition of the data by the sensor to the end of the acquisition of the data by the sensor after the detection of the stopped state, and executing a second authentication process by using the second detection pattern.

9. The authentication method according to claim 8, wherein the obtaining the second detection pattern includes obtaining the second detection pattern based on a group of data which have been acquired by the sensor during a period until the end of the acquisition of the data by the sensor after obtaining the first detection pattern, and executes the second authentication process.

10. The authentication method according to claim 8, wherein the obtaining the second detection pattern includes obtaining the second detection pattern through processing, which differs from that used to obtain the first detection pattern, based on the same group of data as the group used to obtain the first detection pattern, and executes the second authentication process.

11. The authentication method according to claim 8, wherein the obtaining the first detection pattern includes executing an authentication process regarding the detection of the stopped state when the first detection pattern is obtained, and the obtaining the second detection pattern includes executing an authentication process regarding the second detection pattern per se.

12. The authentication method according to claim 8, wherein the obtaining the second detection pattern includes obtaining executing the second authentication process when the first authentication process has succeeded.

13. The authentication method according to claim 8, further comprising:
displaying, in a visually recognizable manner, a degree of progress in the acquisition of the data related to the living body by the sensor.

14. The authentication method according to claim 8, wherein the data related to the living body is a fingerprint image, and
the sensor is a sweep fingerprint sensor.

15. A computer-readable recording medium recording a program providing an authentication function, the program causing a computer to execute:
an acquiring process, through a sensor, data related to a living body, which is input while a relative position of the living body with respect to the sensor is changed;
a first authentication process by using a first detection pattern obtained based on a group of data which have been acquired by the sensor during a period from the start of the acquisition of the data by the sensor to detection of a stopped state of the change in the relative position; and
a second authentication process by using a second detection pattern differing from the first detection pattern and obtained based on a group of data which have been acquired by the sensor during a period from the start of the acquisition of the data by the sensor to the end of the acquisition of the data by the sensor after the detection of the stopped state.
